(19) United States
(12) Patent Application Publication
(10) Pub. No.: US 2024/0128523 A1
(43) Pub. Date: Apr. 18, 2024

(54) MULTI-CONTACT BATTERY STRUCTURE

(71) Applicant: WEN-WEI CHANG, New Taipei City (TW)

(72) Inventor: WEN-WEI CHANG, New Taipei City (TW)

(21) Appl. No.: 17/967,504

(22) Filed: Oct. 17, 2022

(51) Int. Cl. H01M 10/42; H01M 50/512; H01M 50/55; H01M 50/553; H01M 50/557

(52) U.S. Cl. CPC H01M 10/425; H01M 50/512; H01M 50/55; H01M 50/553; H01M 50/557

(57) ABSTRACT

The present invention discloses a multi-contact battery structure comprising at least one battery cell and a protection circuit module. The cell comprises a cell body and a first connection end and a second connection end disposed on different sides of the cell body. The protection circuit module is connected to the first or second connection end. Using the above-mentioned components, a plurality of battery cells are connected through the first or second connection end of each cell body according to the needs of different battery capacities, to form an electrically parallel connection and a battery assembly with different rated capacities, further to form a battery module assembly by the combination, to reduce the waste of electronic products and the carbon emission from the factory production process, to achieve the goal of global environmental protection.

### FIELD OF THE INVENTION

The present invention is in the field of battery-related technology, more particularly, it refers to a multi-contact battery structure.

### BACKGROUND OF THE INVENTION

Many years ago, the specifications of cell phone charging holes were regarded as “contention of a hundred schools of thought”, each manufacturer had its own specifications and cables. However, the specifications of the charging holes in the market have gradually become unified today, with only Micro USB, Type-C, and Lightning specifications three of them remaining, among which, there is a trend that the EU will promote Type-C as a unified standard from the three specifications, while Lightning specifications are now facing the laws and regulations in various countries that require them to move towards the Type-C specification. In addition, the free license given by the Google Project Ara modular phone (building block cell phone), the subsequent Gogoro battery swap patent technology and so on. It can be seen that the unification of specifications is a global consensus and trend, and is the current practice as well.

The battery assembly structure of the prior art generally consists of a battery cell and a protection circuit module. Since the battery cell has a lifetime limit of charging and discharging times, the battery assembly is often regarded as a consumable product.

When the battery cell life expires or the protection circuit module is damaged for some reason, the method for maintenance which normally removes the battery assembly from the electronic product and replaces the battery assembly with a new one, thereby the electronic product can be used continuously.

The battery assembly of the prior art includes at least two independent components, such as the battery cell and the protection circuit module. However, both of them are rarely damaged at the same time, according to statistics. Most of the time, only a single component of the battery cell will be damaged (expiration of the charge/discharge life or degradation), but the protection circuit module remains well without damage.

However, if the battery is directly replaced according to the current repair method, some shortcomings will be faced:
1. Any damage to the battery cell or protection circuit module in the battery assembly, according to the current maintenance practices, either of them will be regarded as damaged and enter the recycling system, resulting in a waste of well-products and resources, but also increasing the burden of the recycling system, which is against the original intention of making the best use of everything.
2. The two major components of the battery assembly, battery cell, and protection circuit module, are compulsorily required for safety certification in various countries, it is well-known that the process of obtaining the safety certification is time-consuming and costly.

As mentioned above, every new model of electronic product nowadays will be presented with a matching shape of the battery assembly, for instance, the lithium batteries used in the new mobile devices or other portable electronic products that launch every year, such as cell phones, tablets, e-books, etc. Since extending the use of the old certified battery assembly is impossible, and the new customized battery assembly must apply for safety certification individually, which may cause a security problem that some unworthy operators might ignore the applying of the certification or fraudulent use of old certification.

### SUMMARY OF THE INVENTION

Therefore, how can a new battery assembly be formed by combining the certified battery cells and protection circuit modules according to the design requirements, to avoid the time and money spent on repeated certifications? or how can the battery cells and protection circuit modules be replaced individually, to avoid wasting resources in case of damage? Given the above, it is essential to improve the structure of the battery assembly.

The main purpose of the present invention is to provide a multi-contact battery structure, which can be combined and expanded according to the demand or only replaced the individual damaged components to avoid waste. In terms of environmental protection, it is always hoped that through the structural innovation and smart assembly concept, improving the manufacturing in the field of batteries to be more convenient and save material costs for manufacturers, and make repairs easier in disassembling and replacing batteries, faster in inspection, and more clear and singular certification for repairers, so that the earth's energy and materials can be fully utilized and conserved, and avoid the waste of manufacturing different battery specifications and the difficulty of common use among them.

Looking at the demand for batteries in today's electronic products is no different from the chaos of cell phone charging hole specifications back then; each manufacturer has its own specifications, sizes, capacities, etc. So, how can we unify the batteries required for electronic products to accomplish a win-win-win situation for manufacturing, maintenance, and certification, to achieve the goal of environmental protection is the main purpose of the present invention.

Through the certified battery cell and protection circuit module, to promote the concept of battery modularization by global battery manufacturers. Whenever there is a demand for a new product that needs a battery, it can be quickly produced a new battery assembly through the combination method, and replace the damaged part with a precise and targeting way during maintenance, to avoid the waste of resources as well as time and money consumption on repeated certification.

According to the purposes of the present invention described above, the present invention proposes a multi-contact battery structure comprising at least one battery cell and a protection circuit module. The battery cell includes a cell body and a first connection end and a second connection end on different sides of the cell body. The protection circuit module is connected to the first or second connection end. By means of the above composition, a plurality of battery cells are connected through the first or second connection end of each cell body, according to the requirements of different battery capacities, to connect each other in parallel electrically and to form a battery assembly with different rated capacities.

### BRIEF DESCRIPTION OF THE DRAWINGS

FIG. 1 is a schematic diagram of the multi-contact battery embodiment of the present invention;

FIG. 2 is a schematic diagram of another embodiment of the battery cell of the present invention;

FIG. 3 is a schematic diagram of another embodiment of the multi-contact battery of the present invention; and

FIG. 4 is a schematic diagram of another embodiment of the battery cell of the present invention.

### DESCRIPTION OF THE PREFERRED EMBODIMENTS

The following is a further description of the embodiment of the multi-contact battery structure of the present invention with reference to the relevant drawings. The various objects in the embodiments are depicted in the proportions, dimensions, deformations, or displacements applicable to the description, rather than in the proportions of the actual components, as indicated. The same and symmetrical configuration of the components in the remaining embodiments are represented by the same number. In addition, the directional terms such as “front, back, left, right, top, bottom, inside, and outside” in the description of each embodiment listed below are in accordance with the specified direction of the view, and cannot be used as an explanation of the restrictions of the invention.

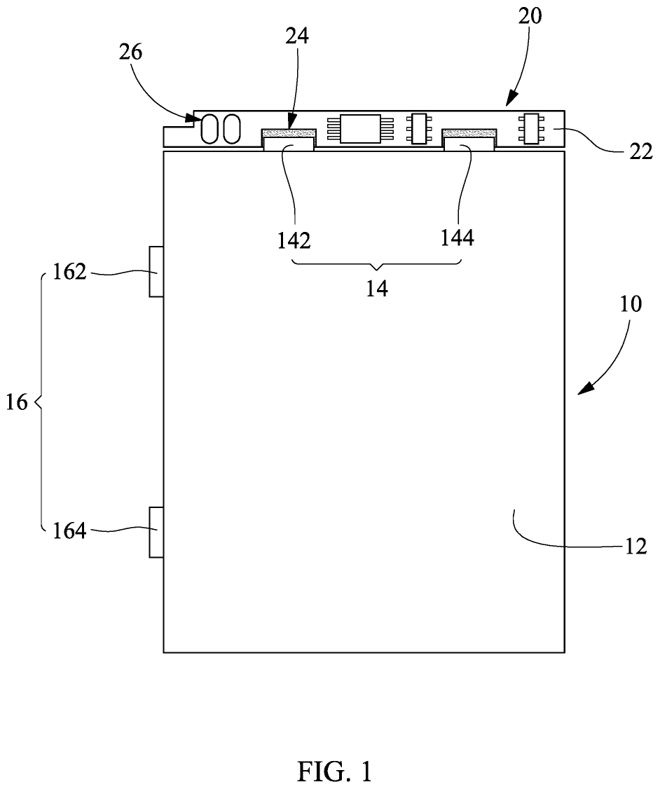

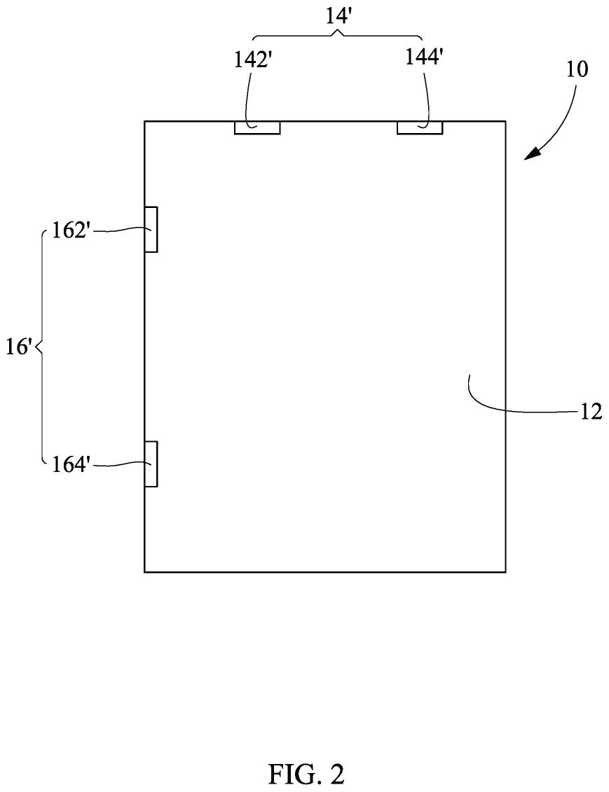

Referring to FIGS. 1 and 2, the multi-contact battery structure of the present invention comprises at least one battery cell 10 and one protection circuit module 20.

The above battery cell 10 further comprises a cell body 12, a first connection end 14, and a second connection end 16.

Said cell body 12 (prior art) has a pre-determined profile, such as a rectangular outer profile, that selectively releases or stores power by chemical reactions within the cell body 12. In an implementation, cell body 12 may be a lead-acid battery, a nickel-cadmium battery, a nickel-hydrogen battery, or a lithium battery.

The first connection end 14 is disposed at either end of the cell body 12 and is internally connected with the cell body 12 for transmitting power. The first connection end 14 includes a first positive lug 142 and a first negative lug 144 in spaced configurations. In an implementation, the first positive and negative lugs 142 and 144 can be in the form of convex plates extending from the outer periphery of the cell body 12, or the first positive and negative lugs 142′ and 144′ may be in the form of a concave plate attached to the outer periphery of the cell body 12 (as shown in FIG. 2). It can also be in the form of an electronic socket or plug that conforms to standard specifications (not shown in the figure, prior art).

The second connection end 16 is disposed at either end of the cell body 12, but not at the same end as the first connection end 14, and is internally connected to the cell body 12 for transmitting power. The second connection end 16 includes a second positive lug 162 and a second negative lug 164 in spaced configurations. In an implementation, the second positive and negative lugs 162 and 164 can be in the form of convex plates extending from the outer periphery of the cell body 12, or the second positive and negative lugs 162′ and 164′ may be in the form of a concave plate attached to the outer periphery of the cell body 12 (as shown in FIG. 2). It can also be in the form of an electronic socket or plug that conforms to standard specifications (not shown in the figure, prior art).

The above protection circuit module 20 (prior art) is connected to the battery cell 10 to regulate and monitor the power exchanged with the battery cell 10. The protection circuit module 20 includes a regulating circuit 22, a first coupling end 24, and a second coupling end 26.

The above first coupling end 24 is connected to the regulating circuit 22 and the first (or second) connection end 14 (16) respectively for transmitting power.

The above second coupling end 26 is connected to the regulating circuit 22 and the power-using (supply) equipment (not shown in the figure) for transmitting power.

The above regulating circuit 22 receives the power transmitted from the first (or second) coupling end 24 (26) and outputs it to the second (or first) coupling end 26 (24) after making a preset regulation.

The above is a description of the various components and assembly methods of a preferred embodiment of the multi-contact battery structure provided by the present invention, and the following are the acting features of the embodiment of the present invention.

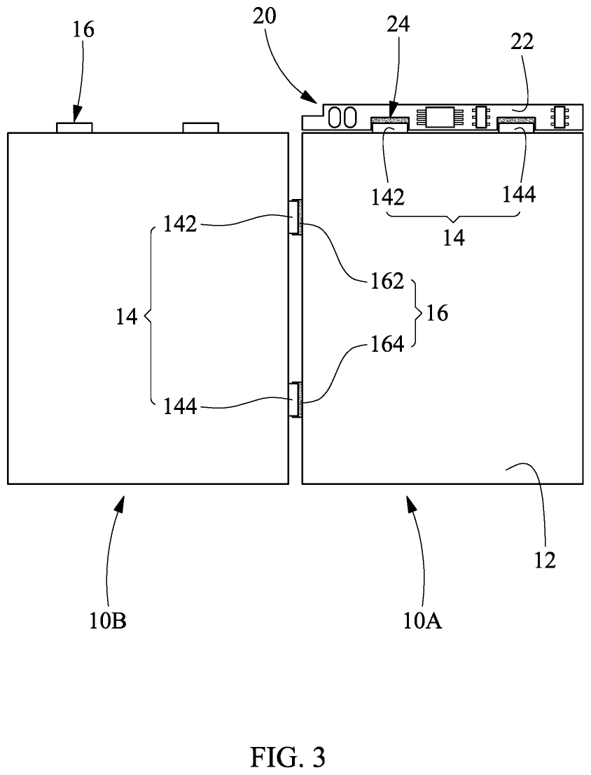

Referring to FIGS. 1 to 3, take two battery cells 10 (e.g., the first and second battery cells 10A and 10B) as an embodiment, the first connection end 14 of the first battery cell 10A is connected to the first coupling end 24 of the protection circuit module 20, and the first connection end 14 or the second connection end 16 of the second battery cell 10B is connected to the second connection end 16 of the first battery cell 10A, to form an electrical parallel. The first connection end 14 or the second connection end 16 of the second battery cell 10B is connected to the second connection end 16 of the first battery cell 10A to form an electrically parallel connection. In an implementation, the connection can be made directly or through an insulated wire.

By combining multiple battery cells 10 in parallel connection, it can meet the rated capacities of the battery assembly required by electronic products, especially for lithium batteries that are used in rapidly updating cell phones, tablets, e-books, etc. Furthermore, since the protection circuit module 20 and the battery cell 10 have obtained safety certification respectively, the battery assembly that is combined by the protection circuit module 20 and multiple battery cells 10 then no longer needs to obtain the safety certification again. Thus, when there is a new formation or with different rated capacities of the battery assembly, it is not necessary to apply for a new safety certification individually, which effectively reduces the time and cost.

Furthermore, the user can replace the protection circuit module 20 and battery cells 10 (first and second battery cells 10A and 10B) individually for maintenance to avoid unnecessary waste.

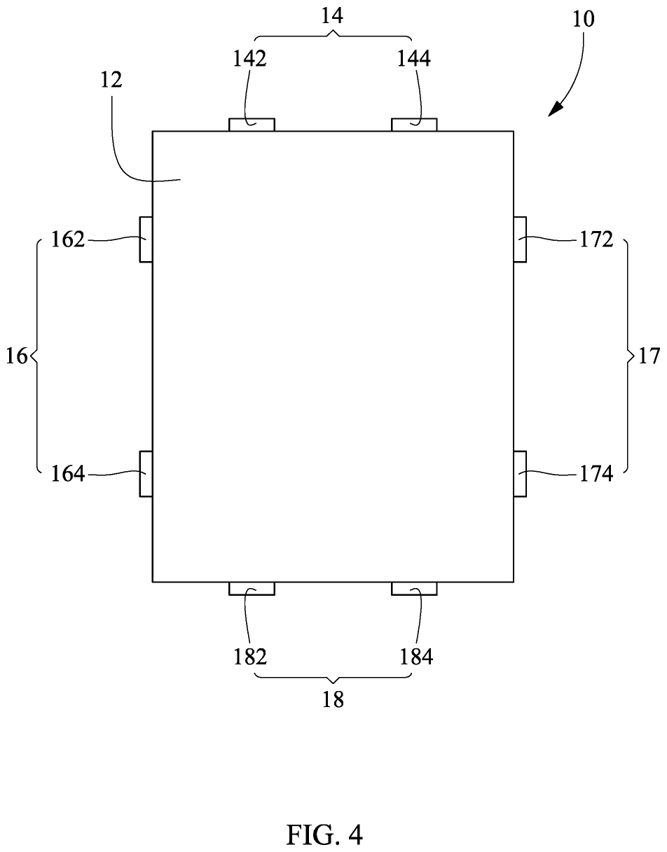

Referring to FIG. 4, the battery cell 10 also includes a third connection end 17, which is disposed at either end of the cell body 12, but not at the same end as the first and second connection ends 14 and 16, and is connected to the internal coil of the cell body 12 for transmitting power, and can be used to connect to another battery cell 10. The third connection end 17 includes a third positive lug 172 and a third negative lug 174 in spaced configurations. In an implementation, the third positive and negative lugs 172 and 174 can be in the form of convex plates extending from the outer periphery of the cell body 12, or in the form of a concave plate attached to the outer periphery of the cell body 12 (not shown in the figure), or in the form of an electronic socket or plug that conforms to standard specifications (not shown in the figure, prior art).

Referring to FIG. 4, the battery cell 10 further includes a fourth connection end 18, which is disposed at either end of the cell body 12, but not at the same end as the first, second, and third connection ends 14, 16, and 17, and is connected to the internal coil of the cell body 12 for transmitting power, and can be used to connect to another battery cell 10. The fourth connection end 18 includes a fourth positive lug 182 and a fourth negative lug 184 in spaced configurations. In an implementation, the fourth positive and negative lugs 182 and 184 can be in the form of convex plates extending from the outer periphery of the cell body 12, or in the form of a concave plate attached to the outer periphery of the cell body 12 (not shown in the figure), or in the form of an electronic socket or plug that conforms to standard specifications (not shown in the figure, prior art).

To better understand the advantages of the present invention, the battery module will be used hereinafter as an example to further compare the differences between the present invention and conventional batteries.

The battery module mainly consists of a “cell protection board”+a “battery cell”. Wherein, the function of the cell protection board: with the protection of overcharge, over-discharge, over-current, short circuit, etc. Due to the early technology limitation, with controlling the shape of the combination and in series connection for the battery cells, and because the aging speed of each battery cell is different, resulting in the mutual influence of the battery cells, leading to a failure of the main body at the same time easily.

The “Active Equalizer” or “Active Protection Equalizer” has been developed in response to the old protection board. The battery charging IC on the protection board is designed to be upgraded and used with MOS tubes, so that all battery cell bodies with different aging speeds can be charged equally, thus improving the problem of overcharging and discharging, as well as protecting the battery and equalizing the voltage, so that the battery can be more durable and prolong the life cycle of the battery cell.

Battery cells, such as lithium polymer batteries, rechargeable lithium batteries (18650, 21700), solid-state batteries, graphene batteries, etc., except for the difference in raw materials and product usage, their ultimate goal is nothing but “electricity storage efficiency”.

Battery module composition: the battery module factory will assemble (cell protection plate+battery cell) to form a product.

Battery cluster: a combination of many batteries connected in parallel, series, or in parallel and series. Currently, they are commonly used in products such as “cell phones, tablets, notebooks, handheld power tools, cordless vacuum cleaners, and motorized vehicles, etc.”

As for the present invention, where is the feature of the “non-obviousness” of the multi-contact battery structure?

The multi-contact battery structure of the present invention has completely changed the current manufacturing status of global production battery factories. Through the multi-contact battery structure, the present invention creates a basic framework that fulfills the concept of fully modularizing the battery modules without hindering the advanced development of cell protection boards and the battery cell materials, and “optimizing” the battery module production processes, product maintenance and accelerating the recycling process in the future.

The improvement of the present invention compared with the conventional battery is that:

Manufacturing: using the combination technology of modularization (building blocks) instead of redesigning according to the demand, significantly reducing the cost (time) of design, component production, inventory, etc., and eliminating the need for overproducing the batteries that cannot be used mutually, so that limited resources can be used effectively.

The manufacturer only needs to produce a single (or a small number of variations) battery cell 10 or protection circuit module 20, which can be modularized (building blocks) by the battery demanders to produce products that meet their own battery specifications, and can be combined in a variety of series and parallel configurations.

Proofing: using the combination technology of modularization (building blocks) to quickly respond to the demand of small quantities and diverse products, and to satisfy the customized needs of high-end groups.

Maintenance: can precisely and accurately replace the damaged parts, such as battery cells 10 or protection circuit modules 20, with no need to replace the entire battery module, only the defective batteries need to be replaced, and the repairers and manufacturers also do not need to stock a large number of different battery models for different specifications, which directly reduces the inventory cost of manufacturing and maintenance, avoiding waste of resources and significantly reducing maintenance costs.

Certification: since the battery cell 10 and the protection circuit module 20 in the present invention have obtained the certification separately, the battery module that uses the combination of the battery cell 10 and protection circuit module 20 in the present invention, for example, does not require to be certified twice, thus saving the cost and waiting time for multiple certifications.

While the present invention has been described by means of specific embodiments, numerous modifications and variations could be made thereto by those skilled in the art without departing from the scope and spirit of the present invention set forth in the claims.

What is claimed is:

1. A multi-contact battery structure comprising:
at least one battery cell, comprising a cell body, a first connection end, and a second connection end, wherein:
the cell body has a pre-determined profile and selectively releases or stores power;
the first connection end, disposed at either side of the cell body, includes a first positive lug and a first negative lug in spaced configurations; and
the second connection end, disposed at either side of the cell body, but not at the same end as the first connection end, comprising a second positive lug and a second negative lug in spaced configurations; and
a protection circuit module, which is connected to the first connection end or the second connection end.

2. The multi-contact battery structure according to claim 1, wherein the first positive lug and the first negative lug are in the form of a convex plate, a concave plate, an electronic socket, or a plug.

3. The multi-contact battery structure according to claim 1, wherein the second positive lug and the second negative lug are in the form of a convex plate, a concave plate, an electronic socket, or a plug.

4. The multi-contact battery structure according to claim 1, wherein the battery cell comprises a third connection end disposed at either end of the cell body, but not at the same end as the first and second connection ends, the third connection end comprising a third positive lug and a third negative lug.

5. The multi-contact battery structure according to claim 4, wherein the third positive lug and the third negative lug are in the form of a convex plate, a concave plate, an electronic socket, or a plug.

6. The multi-contact battery structure according to claim 4, wherein the battery cell comprises a fourth connection end disposed at either end of the cell body, but not at the same end as the first connection end, the second connection end, and the third connection end, the fourth connection end comprising a fourth positive lug and a fourth negative lug.

7. The multi-contact battery structure according to claim 6, wherein the fourth positive lug and the fourth negative lug are in the form of a convex plate, a concave plate, an electronic socket, or a plug.

8. A multi-contact battery structure, comprising:
multiple battery cells, comprising a cell body, a first connection end, and a second connection end, wherein:
the cell body has a pre-determined profile and selectively releases or stores power;
the first connection end, disposed at either side of the cell body, includes a first positive lug and a first negative lug in spaced configurations; and
the second connection end, disposed at either side of the cell body, but not at the same end as the first connection end, comprising a second positive lug and a second negative lug in spaced configurations; and
a protection circuit module, which is connected to the first connection end or the second connection end;
wherein, each of the cells is electrically connected in parallel through the first connection end or the second connection end, and arranged to form a pre-determined profile.

9. The multi-contact battery structure according to claim 8, wherein the first positive lug and the first negative lug are in the form of a convex plate, a concave plate, an electronic socket, or a plug.

10. The multi-contact battery structure according to claim 8, wherein the second positive lug and the second negative lug are in the form of a convex plate, a concave plate, an electronic socket, or a plug.

11. The multi-contact battery structure according to claim 8, wherein the battery cell comprises a third connection end disposed at either end of the cell body, but not at the same end as the first and second connection ends, the third connection end comprising a third positive lug and a third negative lug.

12. The multi-contact battery structure according to claim 11, wherein the third positive lug and the third negative lug are in the form of a convex plate, a concave plate, an electronic socket, or a plug.

13. The multi-contact battery structure according to claim 11, wherein the battery cell comprises a fourth connection end disposed at either end of the cell body, but not at the same end as the first connection end, the second connection end, and the third connection end, the fourth connection end comprising a fourth positive lug and a fourth negative lug.

14. The multi-contact battery structure according to claim 13, wherein the fourth positive lug and the fourth negative lug are in the form of a convex plate, a concave plate, an electronic socket, or a plug.
